(19) United States
(12) Patent Application Publication
(10) Pub. No.: US 2019/0354992 A1
(43) Pub. Date: Nov. 21, 2019

(54) METHOD OF UPDATING FOOD PRODUCT ITEM INFORMATION

(71) Applicant: AVERY DENNISON RETAIL INFORMATION SERVICES, LLC, Mentor, OH (US)

(72) Inventors: Jeanne DUCKETT, Franklin, OH (US); Susan Daum, Miamisburg, OH (US); Lori PORTER, Dayton, OH (US)

(21) Appl. No.: 16/417,293

(22) Filed: May 20, 2019

Related U.S. Application Data
(60) Provisional application No. 62/673,335, filed on May 18, 2018.

(51) Int. Cl. G06Q 30/00; G06F 16/23

(52) U.S. Cl. CPC G06Q 30/018; G06F 16/23

(57) ABSTRACT

A method of remotely updating information related to a food product item is disclosed herein. The method is comprised of configuring an application that can receive nutritional, allergen, dating or other important information specific to the food product. The information may be updatable either automatically or manually. The data is input into the application and linked to a remote database via a key identifier. The food product is then tagged or labeled so that a user may access the most current updated information. The method of the present invention may be used in conjunction with an intelligent printer, such as a RFID, QR code, or barcode printer, a smart device, or a personal computer.

### CROSS-REFERENCE TO RELATED APPLICATION

The present application claims priority to and the benefit of U.S. Provisional Application No. 62/673,335 filed on May 18, 2018, which is incorporated herein by reference in its entirety.

### BACKGROUND

The present invention relates generally to an editing application configured to update nutritional, allergen, shelf life, and other important information related to food products, and more specifically, to a method of using an intelligent device configured to operate the editing application. The editing application of the present invention may be used to create a data file that may be automatically or manually updated to keep the nutritional, allergen, shelf life, and other important information related to a food product current and accurate for the consumer or retailer. The editing application of the present invention further allows for transparency of the related food product information over time, and downstream from the food item producer or manufacturer.

By way of background, the number of food item recalls is increasing each year in the United States and worldwide. One of the major contributors of food recall events is inaccurate food item labeling, which may be caused by incomplete, improper, or out of date nutritional, allergen, dating, or other important information. The recall problem is oftentimes further exasperated by the fact that it is logistically difficult to correct the incomplete or erroneous labelling information after the food product item leaves the manufacturer's or producer's physical control.

In addition, when a new or modified recipe or menu is initiated at a food service provider, such as, but not limited to, a bar, mobile kitchen, restaurant, food truck, convenience stores, etc., the proper and complete nutrition information for the new or modified food product item may not be locally available. This information may include, but is not limited to, the ingredients, calories, nutrients, and percent of recommended daily values related to the food product item. Without proper information (e.g., nutrition information), the retailer, food service provider and/or the consumer will not have the accurate information oftentimes required by federal, state, and local food labelling and related laws.

Additionally, today's consumers are becoming increasingly concerned about food product transparency and the safety of said food product items. Currently, there are no practical implementations of updating information related to a food product item after its generation or preparation through to the consumer. Further, improperly labelled food product items (e.g., food products that are incorrectly identified as being out of date) leads to increased food waste. There are growing environmental, socio-economic and ethical issues and concerns surrounding the amount of food waste occurring in the United States and abroad on a daily basis. For example, it has been reported that Americans alone waste as much as 150,000 tons of food each day, and that, annually, the amount of wasted food has grown on the equivalent of over 30 million acres of cropland, or approximately 7.5% of all harvested cropland in the United States. Therefore, the ability to provide accurate, up to date information related to food products is critical to process improvement and transparency, and reducing the amount of food waste.

While there has been literature written about the need for traceability and providing accurate, up to date information in the foodservice industry throughout the life cycle of the food product item, there are no practical implementations of tracing food and updating information related thereto from its generation or preparation through to the consumer, or the ultimate donation or disposal of the food product. Several reasons for the lack of a practical solution exist.

First, the skill level and available time of the average foodservice worker is relatively limited, thereby reducing the potential of using complex food information updating systems that require multiple steps. Second, available food product information updating technology in the kitchen and other food preparation locations is somewhat limited and typically consists of manual processes requiring the careful recording of information, use of color dots, and finally transcribing the information into a digital record, all of which is not only time consuming, but cost prohibitive, prone to human error, and not easily updatable.

Therefore, there exists in the art a long-felt need for a system or method that allows for accurate and current information to follow a food product item from its generation to its ultimate delivery to a consumer, and that provides users and consumers with greater transparency into the safety of the food product items that they consume. There is also a long-felt need in the art for an automated method of updating information related to a food product item from a remote location. Moreover, having the ability to update information specific to a food product item will enable governments, companies and individuals in the food production chain to improve the overall quality and safety of food product items, comply with federal, state, and local food labelling laws, reduce food waste, and improve overall efficiencies and the sustainability of valuable resources used in the food product production process.

The method of updating information related to a food product item of the present invention overcomes the aforementioned problems and allows for the updating of nutritional, allergen, and related information about the food product item from its generation to its ultimate delivery to a food preparation center, retailer, consumer or donation center. Further, the method of updating information related to a food product item also provides consumers with transparency into the socio and safety impacts of the food product items that they purchase and consume. Additionally, the method of the present invention also provides an automated way of retrieving and updating information from a cloud based database and maintaining the food product information, such as nutritional and allergen information, at a local level and on a timely basis.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a method of updating information related to a food product item. More specifically, the editing application of the present invention allows for the remote updating of nutritional, allergen, dating and other important information related to the food product item from its generation to its ultimate delivery to a food preparation center, retailer, consumer or donation center, and provides transparency into the socio and safety impacts of the food products. As discussed herein, food product updatability refers to the ability to update the nutritional, allergen, and other important information related to the food product item, and display and record that information throughout a food product lifecycle from generation to transformation and, ultimately, consumption.

The method of updating the information related to a food product item of the present invention is primarily comprised of an application having the following three processes: (1) the configuration and setup of the application for a food product item for a local database to link remote food product information via a key identifier; (2) establishing a refresh or update interval and specifying a frequency and time for either refreshing or updating the food product item information automatically, or through a forced manual refresh/update; and (3) performing and validating the refresh/update of the food product item information. A label or tag with the appropriate initial information about the food product item can be printed by, for example, an intelligent printer, RFID encoder or other device, and attached to the food product, its container or other packaging, and the subsequent updating of the same by remote means.

By using an intelligent printer, such as a RFID, quick response (QR), or barcode printer, a smart device or a personal computer running an editing application enabled with cloud-based connectivity, an administrator or other user can create a cloud-connected format data file that can automatically update nutrition, allergen, dating, or other important information related to the food product item. Further, the application can monitor or check, at predetermined programmed time intervals, to determine if the cloud information is either missing or newer than the local printer information or vice versa. If the application determines that the food product information is out of date or missing, it can be automatically updated or provided. Alternatively, an administrator can perform a manual resynchronization that will immediately correct inaccurate food product information and update, and/or provide any missing food product information.

The editing application of the present invention is configured to allow the administrator to link and adapt a remote food product informational database to the locally stored food product information through a series of menu steps, as described more fully below. The menu steps will lead the administrator through the process of properly matching the remote food product informational database to the local food database with respect to one or more food product items via a key identifier field.

Additionally, an internally captured data log of the updates of the food product information, such as nutrition and allergen information, may be kept for viewing at a later time at the discretion of an administrator, either locally on the printer or remotely after extraction. This captured data log will be incrementally modified for every food product information update, and will keep all data log records until a predetermined fixed file size or other user-specified milestone is achieved. The data log will then be stored in a local location and a new data log will be started. When this new data log file reaches the predetermined fixed file size or other user specified milestone is achieved, the new data log file will be stored and the first stored data file may be overwritten or moved to a secondary location.

In a further embodiment of the present invention, the method of updating information related to a food product comprises configuring an application to receive a data set related to the food product. The data set may comprise nutrition, allergen, dating, and other important information related to the food product item, along with any other food product data that may change over time. The data set is printable on a label or tag that is then attachable to the food product or its container or other packaging. Next, the data set is inputted into the application and linked to a remote database via a key identifier associated with the food product item. The remote database comprises timely and accurate updated information related to the food product item. Finally, the data set may also be updated in accordance with the needs or preferences of an administrator or user.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a flow chart depicting one possible method of the present invention of a process for establishing a new food product item in an application, and linking the new food product item to a database.

FIG. 2 illustrates a flow chart depicting one possible method of the present invention of a process for refreshing or updating the database.

FIG. 3 illustrates a flow chart depicting one possible method of the present invention of a process for performing and validating the updating of the food product item database.

FIG. 4 illustrates one possible embodiment of a transactional log displaying the updates and their respective status.

FIG. 5 illustrates a perspective view of one possible embodiment of an intelligent printer having an interactive user display that could be used in conjunction with the methods of the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As previously mentioned, the method of updating food product information is primarily comprised of a software application having the following three processes: (1) the configuration and setup of the application for a new food product item for a local database to link remote food product information to a key identifier; (2) establishing a refresh or update and specifying a frequency and time for either updating the food product item information automatically, or through a forced manual update or refresh; and (3) performing and validating the update of the food product item information. The method and application of the present invention may be used with an intelligent printer, a smart device, or a computer, but is not limited to the same.

To initiate the application configuration and setup phase of the method, it is first necessary to identify within the application those food products or food product ingredients that are going to be subject to periodic updating and/or editing. More specifically, a data set related to the food product must initially be selected or created. The data set may comprise information specific to the food product such as, but not limited to, nutritional information, allergen or sensitivity information, food certification, dating information, or any other important information that suits user need or preference. If it doesn't already reside therein, the data set is then inputted into the application and is locally accessible to a user/consumer of the food product item via a RFID, QR code, or barcode that is printable and attachable to the food product, its container or other packaging and that is linkable to the application. As used herein, “printable” when used in connection with RFID tags, inlays, labels, or devices includes writing information to the RFID tag, inlay, label, or device, for example, by encoding an integrated circuit (e.g., RFID chip) contained in the RFID tag, inlay, label, or device.

The application then links the data set to a remote database comprising timely and accurate updated information related to the selected food product items. Further, the data set associated with the food product item is remotely updatable, either automatically or manually according to a user/administrator's preferences, as explained more fully below.

Once the application has been developed to allow an administrator to edit and update the food product information that is locally stored, the application may also be configured to create synchronization links to update the locally stored food product information, such as nutritional, allergen, and other related information, by accessing a remote database that has remotely stored and more timely, accurate, and up to date food product information. The application may be configured to reside and execute on an intelligent printer, a smart device, or a personal computer. The remote databases may also comprise, but are not limited to, food product information from ESHA Research, FSENet, 1WorldSync, the U.S. Department of Agriculture, or a customer's own point of sales system database or library.

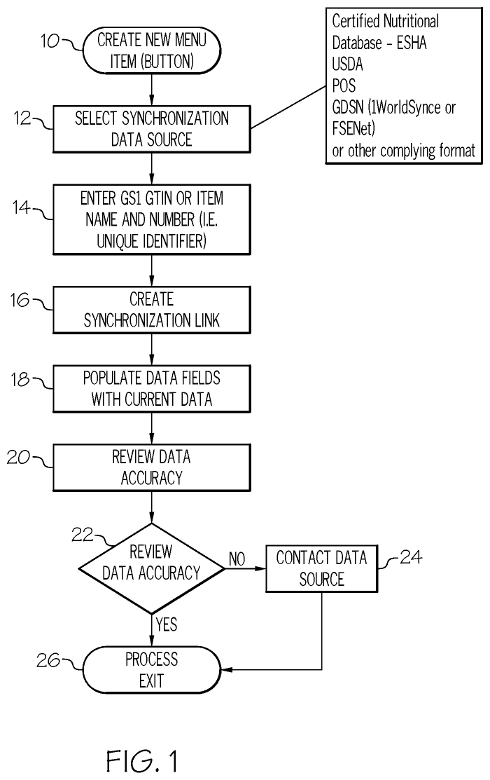

FIG. 1 illustrates a flow chart depicting one possible method of a process for establishing a new food product item in an application that can reside on an intelligent printer, a smart device or a traditional personal computer, and linking the new food product item to food product information stored in a remote database. More specifically, the method begins at step 10, when an administrator initiates the process to configure a data set comprising a plurality of nutritional, allergen, and other food product specific data items into a previously defined plurality of local formats and fields that can be printed or encoded onto a label, referred to as a menu item, to be linked to a remote data source by creating “A New Menu Item” in the application. The New Menu Item specifies a particular food product item. The label may comprise a RFID, QR, or barcode label that is printable on the intelligent printer, a smart device, or a traditional personal computer, and attachable to the food product, its container, or other associated packaging.

Each new food product item can be linked to a separate data source, typically a remote database. The data source can be preconfigured to be readily available in the proper configuration and sequence. In step 12, the remote data source is selected for the food product/menu item that may be, but is not limited to, ready-to-eat, ingredient, or retail grocery items. As previously mentioned, the remote data sources may include, but are not limited to, ESHA Research, FSENet, 1WorldSync, the U.S. Department of Agriculture, or a customer's own point of sales system database or library.

At step 14, a key identifier for the remote data source is generated and entered into the application. The key identifier is used to access the proper information in the remote data source that uniquely matches locally stored information for the specific food product item. This key identifier can be a GS1 GTIN number, or any other unique item number, letter, symbol, or combination thereof, previously defined for that food product item. At step 16, the administrator then approves the creation of a synchronization link between the data set and the remote database for the food product item using the key identifier. Additionally, the data set is printable on the label or tag that is attached to the food product, its container, or other associated packaging.

A plurality of local fields in the application is then populated with matching nutritional, allergen, and other related food product information from the remote data source for each food product/menu item, and the combined population can then be validated in step 18. Depending on the displayed and printed format within the application, this information may be displayed in one to many different nutritional fields that are either merged or that replace existing nutritional information fields. The information may include, but is not limited to, calories, nutrients, a list of ingredients, a nutritional value breakdown, an expiration date, a percent of recommended daily consumption values, etc. Nonetheless, it will be appreciated by those of ordinary skill in the art that the above categories of information and food product item attributes are for illustrative purposes only, and that many other types of information and/or attributes can also be used to create the desired data set and to suit user need or preference.

At step 20, the administrator reviews the food product data for accuracy and completeness. At step 22, the administrator also reviews the concurrent (or companion) food product data which may include, but is not be limited to, a serving size, an amount per serving, a weight, a number of calories, a number of servings per container, a food item weight, a shelf life, etc. For this step, the actual food product with its original manufacturing information labels can be used to validate the online food product data information, or vice versa. If the data is not accurate (e.g., the respective data files don't match), at step 24, the local administrator is instructed to contact the administrator of the remote data source to resolve the conflict, and the process exits at step 26 without saving the link. For example, the food product data conflict may be resolved by updating the data file with missing or incomplete food product data information. If, on the other hand, the food product data is accurate (e.g., the respective data files do match), the process exits in step 26 with a proper link created between the two respective data files. The portion of the method depicted in FIG. 1 (i.e., steps 10 through 26) is repeatable for any new or updated data food products or menu items.

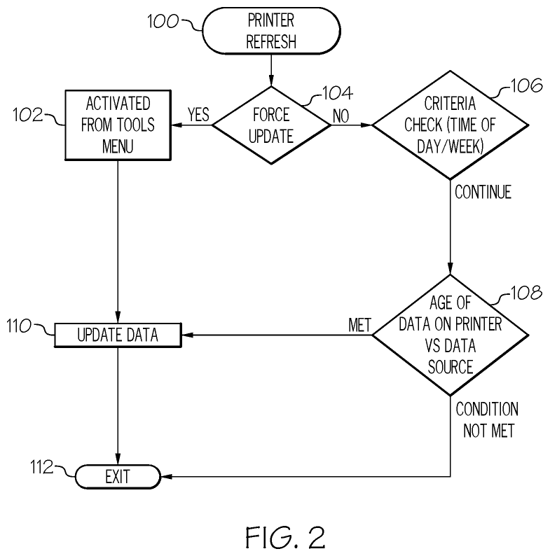

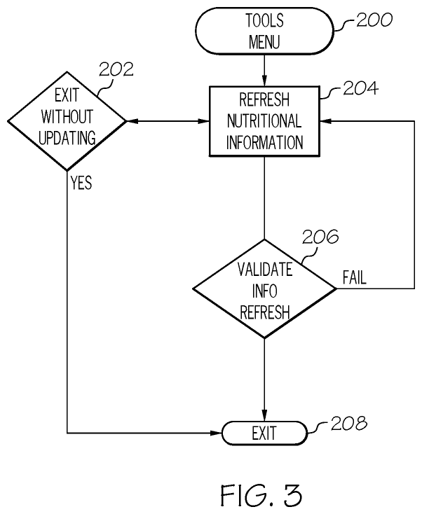

As illustrated in FIG. 2, the method of the present invention may continue at step 100 as the administrator determines how and when the food product data set is to be updated or refreshed. For example, the administrator may decide to perform a forced update, or establish an unmonitored automatic update process at 104. If the user decides on selecting the forced update at step 104, the process proceeds to step 102 where the forced update option may be activated from the tools menu, as illustrated in FIG. 3 and described more fully below. Stated differently, the forced update is simply a manually executed update of the food product data set by the administrator and will, in turn, trigger an update of the food product data set at step 110 before the process exits at step 112.

If, on the other hand, the administrator or user does not select the forced update option at step 104, the process proceeds to step 106 where the application performs a criteria check (e.g., to determine the time of the day, day of the week, or some other user-selected criteria) before proceeding to step 108 to compare the age of the data set on the printer or label with the data source. As explained more fully below, if the criteria in step 106 is satisfied (i.e., because the food product data set requires a refresh or update), the data set is updated at step 110 and the process exits at 112. If, on the other hand, the condition criteria of step 106 is not satisfied, the process bypasses the update data function of step 110 and proceeds to exit the process at 112.

FIG. 3 illustrates a flow chart depicting one possible process for performing and validating the updating of the food product item database. More specifically, the administrator may utilize the tools menu at step 200 to force a manual update of the data set, or the administrator may exit the tools menu without updating the data set at step 202 via step 208. However, if the administrator chooses to update the information, the food product data set, which may contain, for example and without limitation, nutritional information about the food product, is refreshed at step 204. Following the refresh or update of the food product data set at step 204, the application seeks to validate the update at step 206. If the communication and/or the update is validated and confirmed as accurate and complete, the method proceeds to exit the process at step 208. If, on the other hand, the validation is not successful for any reason (i.e., the food product data is not successfully updated) the process returns to step 204 to again attempt the update or refresh and subsequent validation at step 206. The process may be repeated numerous times until a successful validation occurs, at which point the process exits at 208. Notwithstanding, the method of the present invention may proceed to exit at an administrator's discretion. For example, if the data set update is inaccurate, the administrator may erase the updated data set at his or her discretion and exit the system.

Returning to FIG. 2, the administrator may choose not to force an update and to alternatively create a time based criteria (or other user-specified criteria) for updates at step 104, and the process will proceed to step 106. More specifically and by way of example and not limitation, the administrator may enter an update frequency comprising a plurality of time intervals in which to check and update the food product data set. At step 108, the process then checks to see if the current data set in the application residing on the intelligent bar code printer, android printer, smart device, or personal computer is outdated as compared to the remote data source. If the condition is satisfied, meaning that the current data set in the application and assigned to the food product item is out of date or otherwise inaccurate, the data set is updated in step 110 and the process exits in step 112. If the condition is not met, meaning that the data set in the application and assigned to the food product is accurate and complete, the process exits at step 112 with no data update.

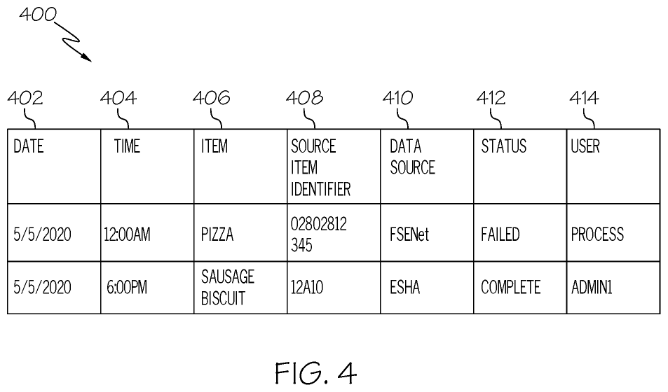

The method of the present invention may further comprise the step of creating a data log of food product data set updates. The data log of updates may comprise a transactional log 400, an example of which is illustrated in FIG. 4. This exemplary transactional log 400 may show relevant capture fields from the remote data update. For example, these fields may include, but are not limited to: a date 402; a time 404; a description of the item 406; a remote source item identifier 408; a data source 410 (e.g., ESHA Research, FSENet, 1WorldSync, the USDA, etc.); the status of the particular update 412; and the identity of the user or administrator 414. If the data set update was completed automatically, the user will preferably be listed as the system. If, on the other hand, the data set update was completed manually, a user/administrator's name or any numerical/alphabetical character combination may be displayed and recorded in the user field 414.

The internally captured data log of the updates of the food product information may be kept for viewing at a later time at the discretion of an administrator, either locally on the printer or remotely after data extraction. This captured data log may be incrementally modified for every food product information update, and may also keep all data log records until a predetermined fixed file size or other user-defined milestone is achieved. The data log may then be stored in a local location, and a new data log started. When the new data log file reaches the predetermined fixed file size of other user-defined milestone, the new data log file may be stored and the first stored data file may be overwritten or transferred to a secondary location.

It is further contemplated that the food product item data sets and related data logs can be transferred to a local server, network, cloud-based application, or hyper ledger for further sharing and/or processing by a user or authorized third party, and that the system could also create the appropriate Electronic Product Code Information Services (EPICS) event record which could also be transferred to a local server, network, cloud-based application, or hyper ledger.

In another possible embodiment, the method of the present invention comprises an intelligent bar code component and an application configured to remotely update a data set created for a food product. The intelligent bar code component may comprise an intelligent bar code printer, a smart device, or a computer. The data set may comprise nutritional, allergen, and other related information data specific to the food product. Additionally, such data set can include the following non-exhaustive list of attributes: date & time; food item description; quantity; unit of measure; product category and sub-category; department; “best by”, “use by”, or other appropriate dates; the value of the food item; and any temperature or other constraints or limitations. Nonetheless, it will be appreciated by those of ordinary skill in the art that the data set described is for illustrative purposes only, and that many other options and/or formats can also be employed to suit user need or preference.

As previously mentioned, the application of the present invention is configured to reside and execute on an intelligent printer/encoder component, though its use and utility is not limited to the same. More specifically, the intelligent printer/encoder component is capable of generating a label, such as a RFID, QR code, or barcode printable on the intelligent printer/encoder, a smart device, or a traditional personal computer, that is attachable to the food product, its container, or other associated packaging. The intelligent printer/encoder component can be used in conjunction with the methods of the present invention to label, mark, or otherwise tag the food product items designated for consumption.

The data set is loadable onto the intelligent printer/encoder component and is linkable to the food product label via a key identifier for the food product. The application is also configured to create synchronization links to update the locally stored nutritional, allergen, and other related information by accessing a remote database that has remotely stored, and more timely and accurate food product information, such as, but not limited to, ESHA, FSENet, 1WorldSync, the USDA, or a customer's own point of sales system database or library. The data set may be updated either manually or automatically at any frequency or interval selected by the user. Any and all updates are verifiable through the application for accuracy and completeness, and the updates may be stored for as long as needed or desired. Further, the inclusion of a barcode or QR code on the label attached to the food product would permit the recipient, or any other user, to scan the barcode or QR code and obtain access to updated current information about the food product item from a web page.

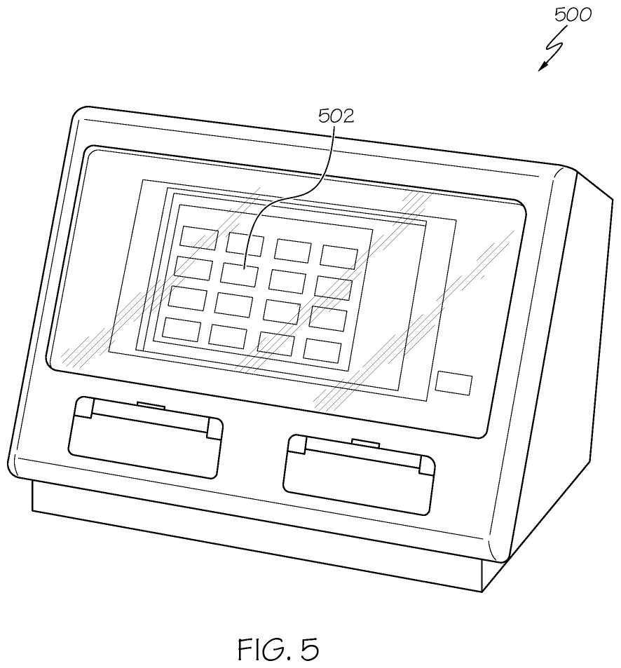

FIG. 5 illustrates a perspective view of one possible embodiment of an intelligent barcode printer 500 having an interactive user display 502 that could be used in conjunction with the methods of the present invention to label, mark, or otherwise tag the food product items and subsequently update the food product information associated with said label. Notwithstanding, intelligent printer 500 is not limited to barcode printers and may be any other type of printer known in the art for producing labels that can be used to mark and/or track an object such as an RFID printer or a printer capable of printing quick response (QR) codes. For example, the inclusion of a QR code on the label attached to a food product item would permit the recipient, or any other user, to scan the QR code and obtain access to accurate, up to date information about the food product item from a web page.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of updating information related to a food product comprising:
configuring an application to receive a data set related to the food product;
inputting the data set into the application;
linking the data set to a remote database; and
updating the data set with information from the remote database.

2. The method of claim 1, wherein the application is executed on at least one of an intelligent printer, a smart device, or a computer.

3. The method of claim 1, wherein the data set is updated automatically according to a predetermined time interval.

4. The method of claim 1, wherein the data set is updated manually.

5. The method of claim 1 further comprising the step of printing a label containing the data set.

6. The method of claim 5 further comprising the step of attaching the label to the food product.

7. The method of claim 1, wherein the data set comprises at least one of the following with respect to the food product: (a) a list of ingredients; (b) a nutritional value breakdown; (c) a percentage of a recommended daily value; or (d) an expiration date.

8. A method of updating locally stored information for a food product comprising:
configuring an application to receive a data set related to the food product;
entering the data set into the application;
generating a key identifier for the food product;
linking the data set to a remote database via the key identifier; and
using the remote database to update the data set.

9. The method of claim 8 further comprising the step of specifying an update frequency.

10. The method of claim 8 further comprising the step of validating the data set.

11. The method of claim 8 further comprising the step of reviewing the data set for accuracy.

12. The method of claim 8 further comprising the steps of printing a label containing the data set and attaching said label to the food product.

13. The method of claim 8, wherein the key identifier is a unique identification number.

14. The method of claim 8, wherein the data set is attached to a label that is linkable to the remote database.

15. The method of claim 8, wherein the data set comprises one or more of the following relative to the food product: (a) a serving size; (b) an amount per serving; (c) a servings per container; (d) a calorie amount; (e) a shelf life; or (f) a weight.

16. A method of updating food product information comprising:
inputting a data set related to the food product into an application;
attaching a copy of at least a portion of the data set to the food product;
using a key identifier to link the application to the food product and update the copy of the at least a portion of the data set when the data set in the application is modified.

17. The method of claim 16 further comprising the step of creating a data log of updates.

18. The method of claim 16 further comprising the step of creating a transactional log for the food product.

19. The method of claim 16, wherein the application resides and is executed on at least one of an intelligent printer, a smart device, and a computer.

20. The method of claim 16, wherein the data set comprises at least one of the following with respect to the food product: (a) a list of ingredients; (b) a nutritional value breakdown; (c) a percentage of a recommended daily value; or (d) an expiration date.
